(19) United States
(12) Patent Application Publication
(10) Pub. No.: US 2026/0265089 A1
(43) Pub. Date: Sep. 10, 2026

(54) Generation of Hydroxyl Radicals in an Advanced Oxidation Reactor

(71) Applicant: Gradiant Corporation, Woburn, MA (US)

(72) Inventors: Chen Yang, Singapore (SG); Hui Han, Singapore (SG)

(21) Appl. No.: 19/161,293

(22) PCT Filed: Mar. 7, 2024
(86) PCT No.: PCT/US2024/018795

§ 371 Date: Sep. 1, 2025

Related U.S. Application Data
(60) Provisional application No. 63/488,783, filed on Mar. 7, 2023.

(51) Int. Cl. C02F 1/467; C02F 1/461

(52) U.S. Cl. CPC C02F 1/4672; C02F 1/46109; C02F 2001/46133; C02F 2303/04; C02F 2305/023

(57) ABSTRACT

Hydroxyl (·OH) radicals are generated in an advanced oxidation reactor by introducing fine bubbles of oxygen (O₂) and/or ozone (O₃) with a diameter of less than 200 μm into an aqueous saline solution in an advanced oxidation reactor vessel that contains an anode and a cathode. A voltage is delivered from a DC power generator to the anode and cathode to generate a potential difference between the anode and cathode, and the introduced oxygen or oxygen from the ozone is reacted in the fine bubbles in the aqueous saline solution to produce hydrogen peroxide (H₂O₂) at the interface of the aqueous saline solution with the cathode. Hydroxyl (·OH) radicals are then generated from the hydrogen peroxide. In another method, where the bubbles may or may not be small, the anode comprises a manganese-based oxide. The hydroxyl radicals can be used to break down organic pollutants via oxidation.

### BACKGROUND

The discussion of the background state of the art, below, may reflect hindsight gained from the disclosed invention(s); and these characterizations are not necessarily admitted to be prior art.

The electro-peroxone (e-peroxone) process is a wastewater treatment method that involves the generation of hydrogen peroxide (H₂O₂) via electrochemical reaction and the generation of hydroxyl radicals from the reaction of the hydrogen peroxide with ozone. This process also includes two well-known water treatment technologies—i.e., ozonation and peroxide oxidation.

During the electro-peroxone process, an electric current is applied to a solution that contains ozone, oxygen, and pollutants. The electric current causes a conversion of oxygen into hydrogen peroxide, which then reacts with ozone to produce hydroxyl (·OH) radicals. Hydroxyl (·OH) radicals are a powerful oxidizing species that can quickly degrade organic pollutants in an advanced oxidation process.

The electro-peroxone process has several advantages over traditional water treatment methods. For example, it can effectively remove a wide range of organic pollutants, including refractory compounds that are resistant to other treatment methods, e.g., ozonation. Additionally, the process may be controlled and optimized to achieve the desired level of treatment, making it a potentially flexible and reliable technology for water treatment applications. Thirdly, the multiple oxidants in the electro-peroxone process (i.e., ozone, H₂O₂, and hydroxyl radicals) have a synergizing effect to achieve the best degradation performance.

The electro-peroxone process has thus far been discussed in papers; however, it has not yet been commercialized due to several reasons. One of the key reasons is that, when operating in the chloride-salted aqueous composition, the H₂O₂ generated on the cathode would diminish quickly with the chlorine/hypochlorite generated on the anode instead of allowing for the reaction of H₂O₂ with O₃ in the desired peroxone reaction. In typical previous electro-peroxone processes, the H₂O₂ is produced in a separate stream rather than in the water treatment stream.

### SUMMARY

An advanced oxidation reactor and a method for generating hydroxyl radicals in an advanced oxidation process are described herein, where various embodiments of the apparatus and methods may include some or all of the elements, features, and steps described below. The reactor and method can efficiently generate, in-situ, H₂O₂ to allow the peroxone reaction to occur.

To practically address the above-referenced issue inhibiting the commercialization of the electro-peroxone process, the reaction of oxygen at the interface of the cathode in an aqueous saline solution promotes H₂O₂ generation; meanwhile, reaction of chlorine evolution on the anode can be prohibited by employing an oxygen-selective anode. The reactor of this disclosure can target a maximum current efficiency of H₂O₂ generation on the cathode while minimizing the current efficiency of chlorine evolution on the anode. Comparing the two factors, prohibiting chlorine generation on the anode is especially advantageous.

In methods described herein, hydroxyl (·OH) radicals are generated in an advanced oxidation reactor by introducing fine bubbles of at least one of oxygen (O₂) and ozone (O₃) with a diameter of less than 200 μm into an aqueous saline solution in an advanced oxidation reactor vessel that contains an anode and a cathode. A voltage is delivered from a DC power supply to the anode and the cathode to generate a potential (voltage) difference between the anode and the cathode; and the introduced oxygen (e.g., from air or oxygen gas) or ozone gas reacts with water on the cathode surface to produce hydrogen peroxide (H₂O₂). Hydroxyl (·OH) radicals are then generated from the hydrogen peroxide reacting with ozone.

In another method, where the bubbles may or may not be fine bubbles, the anode comprises a manganese-based oxide.

Advanced oxidation reactors described herein, and which can be used to perform the above-described process, include a reactor vessel, an anode contained in the reactor vessel, a cathode contained in the reactor, and a fine bubble generator contained in the reactor. The fine bubble generator can be configured to generate fine bubbles with a diameter of less than 200 μm, and/or the anode can comprise a manganese-based oxide.

To maximize H₂O₂-generation efficiency on the cathode, the method can improve O₂ mass transfer by employing fine (sub-200-μm or even sub-10-μm) bubbles of oxygen in the saline solution. Two benefits of employing these fine bubbles include the following. First, the fine bubbles improve the mass transfer of oxygen, thus promoting H₂O₂ generation on the cathode. At the same time, compared with macro-size bubbles, far less oxygen is needed to maximize the dissolved oxygen in the aqueous saline solution. Second, ozone is fed to the fine bubble generator together with oxygen because ozone is usually provided as an O₂/O₃ mixture, so the fine bubbles also improve the mass transfer of ozone in the same way as improving the mass transfer of oxygen, thus reducing the overall cost of the electro-peroxone system.

To minimize reactive chlorine on the anode, the reactor can include an oxygen-selective anode for use in the electro-peroxone process. This type of electrode can be composed of, e.g., a manganese-based oxide (e.g., MnO₂, MnMoOₓ, or MnWOₓ). The oxygen-evolution current efficiencies of these electrodes are usually more than 90%, meaning that the majority of electrons in the electrochemical reaction convert water into oxygen rather than converting chloride into reactive chlorines. Indeed, the method and apparatus described herein can be used for any applications involving in-situ electrochemical H₂O₂ generation. For example, the methods and apparatus can be used for in-situ generation of H₂O₂ for ultraviolet (UV)-H₂O₂ advanced oxidation processes.

The hydroxyl radicals produced via this process and by using this apparatus can be used, e.g., for treating wastewater (from, e.g., industrial wastewater especially non-biologically degradable wastewater) or for purifying water, wherein the hydroxyl radicals can degrade organic pollutants via the reaction of the hydroxyl radicals with organic compounds and/or for disinfection purpose. The methods can also be used for water-based effluent intended for reuse in industrial or other applications.

The advanced oxidation method and the apparatus therefor that are described herein can be operated more cost-effectively and with greater effectiveness than conventional ozonation or peroxone systems. Further, a far lower dosage of oxygen and ozone may be used than is required for conventional methods and systems; and the energy and chemical consumption required for the method can be significantly lower than they are for previous approaches. Further still, the floatation effect provided with the generated fine bubbles can facilitate the removal of suspended solids via flotation to the top of the reactor vessel without any need to engage in downstream solids removal.

### BRIEF DESCRIPTION OF THE DRAWINGS

FIG. 1 is an illustration of an advanced oxidation reactor including a reactor vessel 10 containing a submerged fine bubble generator 16, an anode 12, and a cathode 14; along with an ozone generator 24 configured to supply ozone to the fine bubble generator 16; a wastewater source 26 configured to supply wastewater 25 to the reactor vessel 10; a DC power source 32 for supplying voltage charges to the anode 12 and cathode 14; an ozone destruction unit 34 for destroying ozone 35 extracted from the reactor vessel 10; and an outlet, which can be directed to a receptacle, for treated water 33 produced in the reactor vessel 10. Total suspended solids (TSS) 32 aggregate at the top of the reactor vessel 10.

FIG. 2 includes bar graphs representing the current efficiency of generating H₂O₂ in an electrochemical cell in different concentrations of NaCl coupled with a dimensionally stable platinum anode 36 and a MnMoOₓ anode 38 for each NaCl concentration.

FIG. 3 includes plots of the concentration of 2-propanol (IPA) over its initial concentration (C/Cₒ) over time with the treatment of 2-propanol (IPA) by an electro-peroxone process using a platinum anode 36 compared with a MnMoOₓ anode 38 in a 1-weight-% NaCl solution.

FIG. 4 is another schematic illustration of a fine-bubble generator 16 in a retention tank 40 and an electro-peroxone reactor vessel 10.

FIG. 5 includes plots of the concentration of 2-propanol (IPA) over its initial concentration (C/Cₒ) as a function of treatment time with macrobubbles of ozone 50 compared with fine bubbles of ozone 48.

In the accompanying drawings, the same reference characters refer to the same or similar parts throughout the different views; and apostrophes are used to differentiate multiple instances of the same item or different embodiments of items sharing the same reference numeral. The drawings are not necessarily to scale; instead, an emphasis is placed on illustrating particular principles in the exemplifications discussed below. For any drawings that include text (words, reference characters, and/or numbers), alternative versions of the drawings without the text are to be understood as being part of this disclosure; and formal replacement drawings without such text may be substituted therefor.

### DETAILED DESCRIPTION

The foregoing and other features and advantages of various aspects of the invention(s) will be apparent from the following, more particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise herein defined, used, or characterized, terms that are used herein (including technical and scientific terms) are to be interpreted as having a meaning that is consistent with their accepted meaning in the context of the relevant art and are not to be interpreted in an idealized or overly formal sense unless expressly so defined herein. For example, if a particular composition is referenced, the composition may be substantially (though not perfectly) pure, as practical and imperfect realities may apply; e.g., the potential presence of at least trace impurities (e.g., at less than 1 or 2%) can be understood as being within the scope of the description. Likewise, if a particular shape is referenced, the shape is intended to include imperfect variations from ideal shapes, e.g., due to manufacturing tolerances. Percentages or concentrations expressed herein can be in terms of weight or volume. Processes, procedures, and phenomena described below can occur at ambient pressure (e.g., about 50-120 kPa—for example, about 90-110 kPa) and temperature (e.g., −20 to 50° C.—for example, about 10-35° C.) unless otherwise specified.

Although the terms, first, second, third, etc., may be used herein to describe various elements, these elements are not to be limited by these terms. These terms are simply used to distinguish one element from another. Thus, a first element discussed below could be termed a second element without departing from the teachings of the exemplary embodiments.

Spatially relative terms, such as “above,” “below,” “left,” “right,” “in front,” “behind,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein are to be interpreted accordingly. The term, “about,” can mean within ±10% of the value recited. In addition, where a range of values is provided, each subrange and each value between the upper and lower ends of the range is contemplated and, therefore, disclosed.

Further still, in this disclosure, when an element is referred to as being “on,” “connected to,” “coupled to,” “in contact with,” etc., another element, it may be directly on, connected to, coupled to, or in contact with the other element or intervening elements may be present unless otherwise specified.

The terminology used herein is for the purpose of describing particular embodiments and is not intended to be limited to exemplary embodiments. As used herein, singular forms, such as those introduced with the articles, “a” and “an,” are intended to include the plural forms as well, unless the context indicates otherwise. Additionally, the terms, “includes,” “including,” “comprises,” and “comprising,” specify the presence of the stated elements or steps but do not preclude the presence or addition of one or more other elements or steps.

Additionally, the various components identified herein can be provided in an assembled and finished form; or some or all of the components can be packaged together and marketed as a kit with instructions (e.g., in written, video, or audio form) for assembly and/or modification by a customer to produce a finished product.

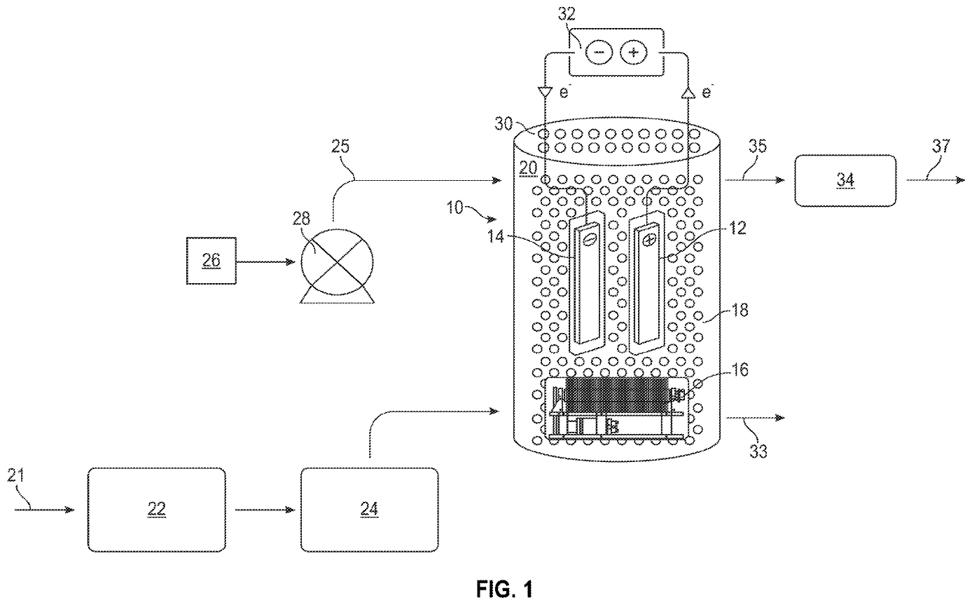

An advanced oxidation reactor, as shown in FIG. 1, includes a reactor vessel 10, an anode 12, and a cathode 14 contained in the reactor vessel 10, and a gas distributor or diffuser 16 contained in the reactor. The gas distributor/diffuser 16 is configured to distribute gas in either macro or fine bubbles 18 into the aqueous saline solution 20 to be treated in the reactor vessel 10.

The cathode 14 can be an inert electrode, formed of, e.g., titanium, carbon/graphite, boron-doped diamond (BDD), tin oxide, etc. In particular embodiments, the cathode 14 is a carbon-based material comprising at least 99% carbon, including, but not limited to, carbon fiber, graphene, carbon nanotubes, and/or carbon cloth.

The anode 12 can be a dimensionally stable anode (DSA) and can be formed of, e.g., a composition selected from at least one manganese-based oxide [e.g., manganese oxide (MnO₂), manganese-molybdenum oxide (MnMoOₓ), or manganese-tungsten oxide (MnWOₓ), coated titanium], iridium, tantalum, ruthenium, platinum, and palladium; alternatively, the anode 12 can be formed of a carbon-based composition, such as boron-doped diamond. These compositions can be coated on a substrate formed, e.g., of titanium. To restrict chlorine production in chloride-rich water, coating the anode 12 with manganese-based oxides facilitates the selective oxidization of water molecules instead of chloride. The current efficiency of oxygen generation on those coatings was generally recorded as being higher than 90% (in some cases, even >99% current efficiency was achieved). Those special coatings will be referred to as chlorine-free anodes thereafter.

For further discussion of manganese-based anodes, see K. Fujimura, et al., “Oxygen evolution on manganese-molybdenum oxide anodes in seawater electrolysis,” Materials Science and Engineering: A, 267(2), 254-259 (1999); U.S. Pat. No. 4,180,445 (Bennett, et al.); and K. Izumiya, et al., “Anodically deposited manganese oxide and manganese-tungsten oxide electrodes for oxygen evolution from seawater,” Electrochimica Acta, 43.21-22, 3303-3312 (1998).

A gas distributor or diffuser 16, e.g., a fine bubble generator, is also employed near the cathode 14 to supply oxygen and/or ozone. In the exemplification shown in FIG. 1, ambient air 21 is fed to an oxygen concentrator 22; an oxygen-enriched stream is then fed to an ozone generator 24, which can feed a mixture of ozone (O₃) and oxygen (O₂) gas from the oxygen concentrator 22 into the reactor vessel 10. To improve oxygen-transfer performance to the cathode surface, the gas distributor or diffuser device 16 can be a nano- or micro-bubble or any fine bubble generator. When ozone (e.g., an ozone/oxygen or air mixture) is supplied to the fine bubble-generating device 16, the reactor performs an electro-peroxone process.

Wastewater 25 containing organic compounds can be fed by a pump 28 from a wastewater source 26 into the reactor vessel 10, wherein the oxygen and ozone are used in an electro-peroxone process to produce hydroxyl radicals that break down organic matter in the wastewater via oxidation. Suspended solids 30 from the wastewater collect at the top of the reactor vessel 10.

A direct-current (DC) power source 32 applies opposing electric charges to the anode 12 and the cathode 14 to create a charge differential therebetween. Furthermore, treated water 33 (produced via the treatment by the hydroxyl-radical oxidation of organic matter in the wastewater 25) is extracted from the reactor vessel 10 for, e.g., storage in a reservoir, while the residual ozone and oxygen mixture gas 35 is also extracted from a gas volume at the top of the reactor vessel 10 and fed through an ozone destruction unit 34 in which a catalyst can catalyze the ozone (O₃) back into oxygen (O₂) 37, which can be safely released into the ambient air.

Additional details of an advanced oxidation reactor and its use are described in WO 2021/211231 A2 (Carbon-Coated, Transition-Metal Electrodes for Advanced Oxidation Reactors).

Influence of Chlorine-Free Anodes on Electrochemical Generation of H₂O₂ in NaCl-Salted Water:

### Example 1

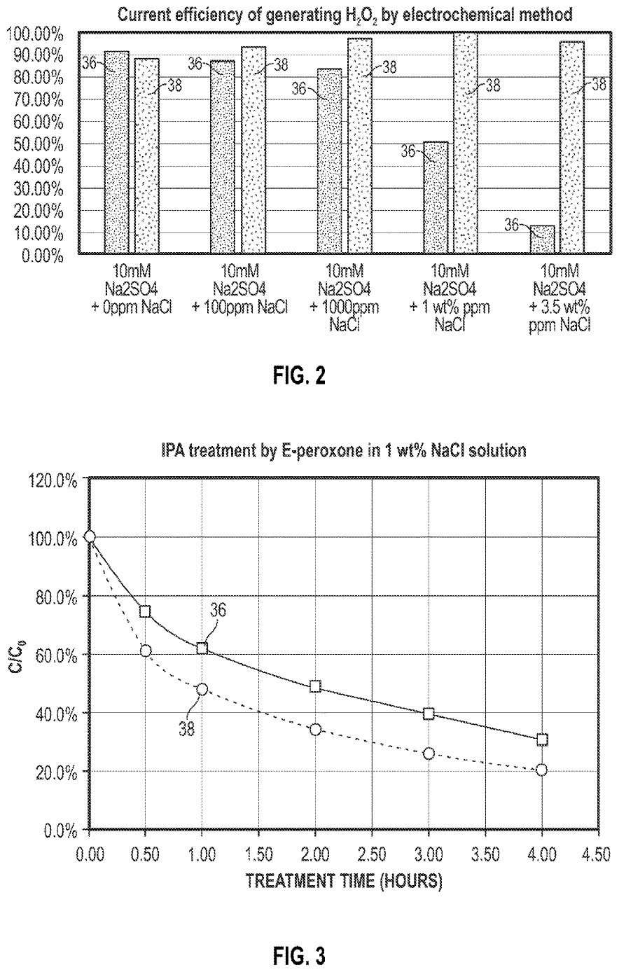

Performance in terms of the current efficiency of an electrochemical H₂O₂ generator is shown in FIG. 2 for a dimensionally stable platinum-coated titanium anode 36 at 9C charge and a MnMoOₓ anode 38 at 9C charge. The cathode 14, in this example, is a piece of carbon cloth. The MnMoOₓ electrode 38 was synthesized following the experimental procedures as described in K. Fujimura, et al., “Oxygen evolution on manganese-molybdenum oxide anodes in seawater electrolysis,” Materials Science and Engineering: A, 267 (2), 254-259 (1999). A titanium stone diffuser 16 (that produces bubbles with a diameter of 10 μm-300 μm) was employed to deliver macrobubbles 18 of O₂ at a gas flow rate of 2 liters per minute (lpm) into the generator.

The H₂O₂ was then generated on the cathode 14 in electrolytes (500 ml) with various NaCl concentrations. The H₂O₂ concentration was measured by the classic titration method; then the current efficiency was calculated when a 9 coulomb (C) charge passed through the cell. For comparison, tests in the same cell employing a normal dimensionally stable platinum-coated titanium electrode 36 as the anode 12 were also performed.

As shown in FIG. 2, all tests in an H₂O₂ generator coupled with a MnMoOₓ anode 38 showed very high current efficiency, around 90%, regardless of the NaCl concentration in the aqueous saline solution 20. In contrast, when a normal dimensionally stable platinum-coated titanium electrode 36 anode is used in the cell, current efficiency decreases with increasing NaCl concentration in the aqueous saline solution 20. Eventually, the current efficiency drops to only 13% when the aqueous saline solution 20 is salted with 3.5% NaCl.

Influence of Chlorine-Free Anodes on the e-Peroxone Process:

### Example 2

The influence of chlorine-free anodes was also carefully examined in a water-treatment process by the electro-peroxone approach. The test was performed in 500 ml of 1-weight % NaCl solution. Ozone is in-situ generated by an HTU ozone generator 24 (for generating O₃ at a 2-3% concentration and operating at 25 W). A titanium stone gas diffuser was used as the gas diffuser 16 to transfer oxygen/ozone macrobubbles 18 at a flow rate of 2 lpm. The cathode 14 was a piece of carbon cloth electrode. The anode 12 was a platinum (Pt) coated anode 36 or a MnMoOₓ special anode 38 for comparison.

2-propanol was selected as the organic pollutant in the wastewater 25. The concentration of 2-propanol was measured by a TOC-L series total organic carbon analyzer from Shimadzu Corporation of Kyoto, Japan; and the starting concentration, Cₒ, in terms of the total organic carbon (TOC) was 22.5 ppm. The process started when DC current was applied to the carbon cloth electrode, and the TOC was monitored during the treatment process.

The result is shown in FIG. 3, which includes plots of the TOC over its initial TOC versus time on the treatment of 2-propanol (IPA) by an electro-peroxone process using a platinum anode 36 compared with a MnMoOₓ anode 38 in a 1-weight-% NaCl solution. In general, the electro-peroxone process with a MnMnOx special anode 38 reduces the treatment time by nearly half of that for the platinum anode 36. The result is consistent with our findings in Example 1 that H₂O₂ production was significantly reduced in 1-wt % NaCl salted water when Pt was employed as the anode, indicating that lower H₂O₂ production contributes to the lower electro-peroxone performance.

Influence of Fine Bubbles on Electrochemical H₂O₂ Generation:

### Example 3

Electrochemical H₂O₂ generation was performed on a single-piece carbon-cloth cathode 14 in a retention tank filled with 5 liters of aqueous saline solution 20 in which 100 mM Na₂SO₄ was dissolved. A platinum electrode 36 was employed as the anode 12. A cathodic current of 0.45 A was then applied to the carbon cloth cathode 14 to generate H₂O₂. The gas distributor 16 was a fine bubble generator configured to generate bubbles from 100 nm to 10 μm. In comparison, a titanium stone diffuser (for generating a bubble size distribution of 10 μm-300 μm) was employed as the gas diffuser 16 to generate macrobubbles. Pure oxygen was supplied at the same flow rate of 0.5 lpm. The H₂O₂ current efficiency was calculated when a 135 C charge passed through the cathode 14. Eventually, the current efficiency achieved by the fine bubble generator was 72.48% compared to the 32.99% achieved by the titanium stone diffuser.

### Example 4

Experiments of electrochemical H₂O₂ generation were also performed in the electro-peroxone reactor vessel 10. The vessel employs a carbon cloth electrode as the cathode 14 and an IrO₂-coated titanium electrode as the anode 12. A current of 1.6 A was applied to the cathode 14 to generate H₂O₂.

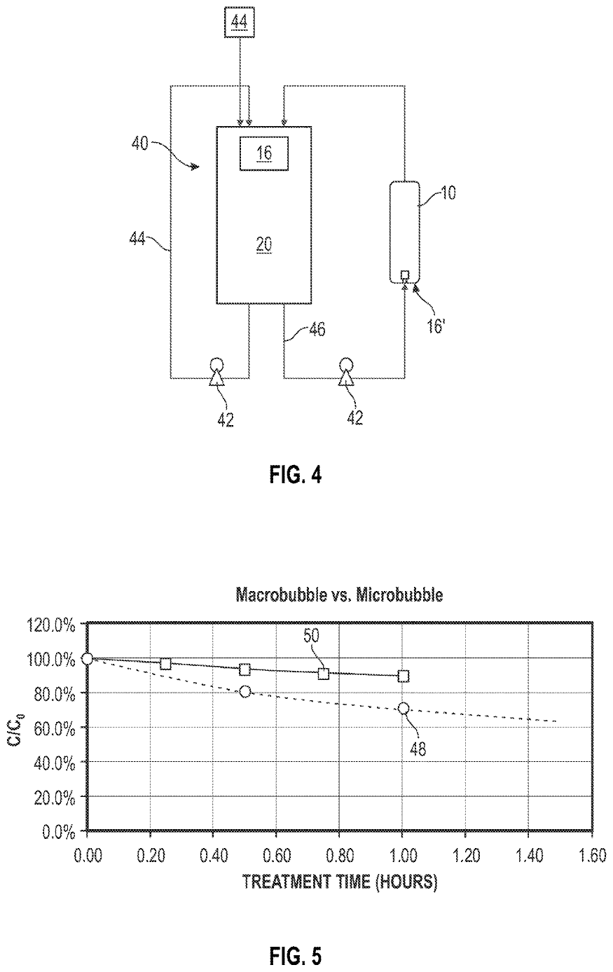

The process flow is illustrated in FIG. 4. When fine bubbles were employed to transport O₂ molecules to the surface of the carbon cloth cathode, a fine bubble generator 16 for generating a bubble size distribution from 100 nm to 10 μm was coupled with an O₂ source 44, which was placed into a separate retention tank 40 filled with 6 liters of aqueous saline solution 20 in which 10 mM of Na₂SO₄ was dissolved and which is recirculated by a pump 42 through a recirculation loop 44. Aqueous saline solution 20 from the retention tank 40 was also bypassed using another pump 42 and a second loop 46 to the electro-peroxone reactor vessel 10 with a stone diffuser 16′ therein to bring these fine O₂ microbubbles to the reactor vessel 10.

In comparison, H₂O₂ generation performance was also conducted when a titanium stone gas diffuser for generating a bubble size distribution of 10 μm-300 μm was placed in the reactor vessel 10 to bubble oxygen. In this case, macrobubbles were supplied to the reactor vessel 10 directly. Pure oxygen was supplied to both bubblers at the same flow rate of 0.5 lpm. Eventually, the current efficiency achieved by the microbubble aerator was 65.21% compared to the 44.68% efficiency achieved by the stone diffuser.

The reactor vessel was not yet optimized. Nevertheless, under the same test circumstances, the difference between microbubbles and macrobubbles in H₂O₂ production is very well evidenced, especially considering that the microbubbles were bypassed to the reactor vessel 10.

### Influence of Fine Bubbles on an Electro-Peroxone Process.

### Example 5

The influence of fine bubbles in a real electro-peroxone process was also evaluated in the same process setup as is described in Example 4 using our reactor vessel 10. To introduce ozone into the system, an HTU ozone generator 24 (generating O₃ at a 2-3% concentration and operating at 25 W) was employed and operated at its maximum power. The ozone/oxygen mixture was subsequently transferred to either the fine bubble generator or to the titanium stone diffuser as the gas distributor 16, as mentioned in the previous examples. In this experiment, the oxygen flow rate was set at 0.2 lpm.

2-propanol was again selected as the source of organic pollutant and dissolved into 6 liters of water in which 10 mM of Na₂SO₄ was dissolved in the retention tank 40. The concentration of 2-propanol was measured by the TOC-L analyzer (from Shimadzu Corporation); and the starting concentration, Cₒ, in terms of total organic carbon (TOC) is 22.5 parts per million (ppm). The process started when DC current was applied to the carbon-cloth cathode 14, and the TOC was monitored during the treatment process. The result is shown in FIG. 5, where the fine bubble electro-peroxone process 48 is revealed to significantly improve the overall performance of the advanced oxidation process in comparison with the macrobubble electro-peroxone process 50. This improvement is not only attributed to better H₂O₂ production, as is discussed in regard to Example 4, but also to the fine bubbles of oxygen and ozone that improved the peroxone reaction kinetics.

In describing embodiments, herein, specific terminology is used for the sake of clarity. For the purpose of description, specific terms are intended to at least include technical and functional equivalents that operate in a similar manner to accomplish a similar result. Additionally, in some instances where a particular embodiment includes a plurality of system elements or method steps, those elements or steps may be replaced with a single element or step. Likewise, a single element or step may be replaced with a plurality of elements or steps that serve the same purpose. Further, where parameters for various properties or other values are specified herein for embodiments, those parameters or values can be adjusted up or down by 1/100^{th}, 1/50^{th}, 1/20^{th}, 1/10^{th}, ⅕^{th}, ⅓^{rd}, ½, ⅔^{rd}, ¾^{th}, ⅘^{th}, 9/10^{th}, 19/20^{th}, 49/50^{th}, 99/100^{th}, etc. (or up by a factor of 1, 2, 3, 4, 5, 6, 8, 10, 20, 50, 100, etc.), or by rounded-off approximations thereof or within a range of the specified parameter up to or down to any of the variations specified above (e.g., for a specified parameter of 100 and a variation of 1/100^{th}, the value of the parameter may be in a range from 0.99 to 1.01), unless otherwise specified. Further still, where methods are recited and where steps/stages are recited in a particular order—with or without sequenced prefacing characters added for ease of reference—the steps/stages are not to be interpreted as being temporally limited to the order in which they are recited unless otherwise specified or implied by the terms and phrasing.

While this invention has been shown and described with references to particular embodiments thereof, those skilled in the art will understand that various substitutions and alterations in form and details may be made therein without departing from the scope of the invention. Further still, other aspects, functions, and advantages are also within the scope of the invention; and all embodiments of the invention need not necessarily achieve all of the advantages or possess all of the characteristics described above. Additionally, steps, elements, and features discussed herein in connection with one embodiment can likewise be used in conjunction with other embodiments. The contents of references, including reference texts, journal articles, patents, patent applications, etc., cited throughout the text are hereby incorporated by reference in their entirety for all purposes; and all appropriate combinations of embodiments, features, characterizations, and methods from these references and the present disclosure may be included in embodiments of this invention. Still further, the components and steps identified in the Background section are integral to this disclosure and can be used in conjunction with or substituted for components and steps described elsewhere in the disclosure within the scope of the invention.

1. A method for generating hydroxyl (·OH) radicals in an advanced oxidation reactor, the method comprising:
introducing fine bubbles of at least one of oxygen (O₂) and ozone (O₃) with a diameter of less than 200 μm into an aqueous saline solution in an advanced oxidation reactor vessel, wherein the reactor vessel contains an anode and a cathode in the aqueous saline solution;
delivering a voltage from a DC power supply to the anode and the cathode to generate a potential difference between the anode and the cathode;
reacting the introduced oxygen or ozone with the cathode to produce hydrogen peroxide (H₂O₂) at an interface of the aqueous saline solution with the cathode; and
generating hydroxyl (·OH) radicals from the hydrogen peroxide.

2. The method of claim 1, wherein the generation of the hydroxyl radicals comprises:
introducing bubbles of ozone (O₃) into the aqueous saline solution; and
reacting the ozone with the hydrogen peroxide to produce the hydroxyl radicals.

3. The method of claim 1, wherein the anode comprises a manganese-based oxide.

4. The method of claim 1, wherein the anode comprises at least one of iridium, tantalum, ruthenium, platinum, and palladium.

5. The method of claim 1, wherein the cathode is a carbon-based material.

6. The method of claim 5, wherein the carbon-based material is configured as a cloth, fibers, nanotubes, a graphene sheet or a graphene 3D material.

7. The method of claim 1, wherein the fine bubbles are introduced via a fine bubble generator that generates bubbles with a diameter at least 1 μm and up to 10 μm for micro bubbles or nano bubbles with a diameter of less than 1 μm.

8. The method of claim 7, wherein the generation of the hydroxyl radicals comprises:
introducing bubbles of ozone (O₃) into the aqueous saline solution; and
reacting the ozone with the hydrogen peroxide to produce the hydroxyl radicals,
wherein the bubbles of ozone that react with the hydrogen peroxide are also introduced via the fine bubble generator.

9. The method claim 1, wherein the aqueous saline solution comprises chloride ions.

10. The method of claim 1, further comprising using the hydroxyl radicals to break down organic pollutants via oxidation.

11. An advanced oxidation reactor, comprising:
a reactor vessel;
an anode contained in the reactor vessel;
a cathode contained in the reactor vessel; and
a fine bubble generator contained in the reactor, wherein the fine bubble generator is configured to generate fine bubbles with a diameter of less than 200 μm.

12. The advanced oxidation reactor of claim 11, wherein the anode comprises a manganese-based oxide.

13. The advanced oxidation reactor of claim 11, wherein the anode comprises at least one of iridium, tantalum, ruthenium, platinum, and palladium.

14. The advanced oxidation reactor of claim 11, wherein the cathode is a carbon-based material.

15. The advanced oxidation reactor of claim 14, wherein the carbon-based material is configured as a cloth, fibers, nanotubes, a graphene sheet, or a graphene 3D material.

16. The advanced oxidation reactor of claim 11, further comprising a source of at least one of oxygen and ozone coupled in fluid communication with the fine bubble generator.

17. The advanced oxidation reactor claim 11, further comprising a DC power supply electrically coupled with the anode and the cathode.

18. The advanced oxidation reactor of claim 11, further comprising a source of aqueous saline solution in fluid communication with the reactor vessel.

19. The advanced oxidation reactor of claim 11, wherein the aqueous saline solution comprises chloride ions.

20. The advanced oxidation reactor of claim 11, wherein the fine bubble generator is configured to generate fine bubbles with a diameter no greater than 10 μm.

21. A method for generating hydroxyl (·OH) radicals in an advanced oxidation reactor, the method comprising:
introducing bubbles of at least one of oxygen (O₂) and ozone (O₃) in an advanced oxidation reactor vessel, wherein the reactor vessel contains an anode and a cathode in an aqueous saline solution, and wherein the anode comprises a manganese-based oxide;
delivering a voltage from a voltage source and/or a current from a current source to the anode and to the cathode to generate a potential difference between the anode and the cathode;
reacting the introduced oxygen or oxygen from the ozone in the aqueous saline solution to produce hydrogen peroxide (H₂O₂) at an interface of the aqueous saline solution with the cathode; and
generating hydroxyl (·OH) radicals from the hydrogen peroxide.

22. The method of claim 21, wherein the generation of the hydroxyl radicals comprises:
introducing bubbles of ozone (O₃) into the aqueous saline solution; and
reacting the ozone with the hydrogen peroxide to produce the hydroxyl radicals.

23. The method of claim 22, wherein the bubbles of the at least one of oxygen (O₂) and ozone (O₃) have a diameter of less than 200 μm.

24. The method of claim 21, wherein the cathode is a carbon-based material.

25. The method of claim 24, wherein the carbon-based material is configured as a cloth, fibers, nanotubes, a graphene sheet, or a graphene 3D material.

26. The method of claim 21, wherein the bubbles of the at least one of oxygen (O₂) and ozone (O₃) are introduced via a fine bubble generator.

27. The method of claim 26, wherein the bubbles of ozone that react with the hydrogen peroxide are also introduced via the fine bubble generator.

28. The method of claim 21, wherein the aqueous saline solution comprises chloride ions.

29. The method of claim 28, further comprising using the hydroxyl radicals to break down organic pollutants via oxidation.

30-37. (canceled)
